(19) United States
(12) Patent Application Publication
(10) Pub. No.: US 2011/0286663 A1
(43) Pub. Date: Nov. 24, 2011

(54) Method And Apparatus Of Color Image Rotation For Display And Recording Using JPEG

(76) Inventor: Wen-Lung Huang, Hsinchu (TW)

(21) Appl. No.: 12/783,557

(22) Filed: May 20, 2010

(51) Int. Cl. G06K 9/36

(52) U.S. Cl. 382/166; 345/656

(57) ABSTRACT

A method and apparatus of color image rotation for display and recording using JPEG compression and decompression is provided. The method includes the steps of: setting the operation modes of JPEG encoder and JPEG decoder respectively; waiting until the image data ready for encoding; performing JPEG encoding and reentry information processing; waiting until the compression of one entire frame of image completed; setting the operation mode of JPEG encoder; and then performing JPEG decoding and reentry information updating processing. For displaying the image on an image output device, the method includes the steps of: displaying processing; waiting until JPEG decoding completed; and displaying final image on the display. At this point, the process of one frame display is accomplished. On the other hand, for recording to a mass storage device, the method includes the steps of: standard lossless JEPG encoding; waiting until JPEG encoding completed; and storing final encoded data to the mass storage device. At this point, the process to record one frame image is accomplished.

### FIELD OF THE INVENTION

The present invention generally relates to color image processing, and more specifically to a method and apparatus of color image rotation for display and recording using JPEG.

### BACKGROUND OF THE INVENTION

Even prior to the recent popularity of the smart phones, image rotation is an important must-have function for image manipulation software applications for computer. The fierce competition of the booming smart phone market fuels the demand of fast image rotation computing capability even further. Nowadays, the image rotation function is an indispensible part of any image-based devices or peripherals, such as, displays (e.g., liquid crystal display (LCD)) and storage devices (e.g., NAND flash memory). The image rotation computation must take the image representation into account. For example, the format of the image file has great impact on the rotation computation efficiency and the final data size for storage. For example, Image capture device, such as, CCD, CMOS camera module, etc., scans the real vision to be captured and outputs the image information as serial RGB or YUV input format (YCbCr model is usually viewed as a shifted version of YUV).

JPEG is a widely used method for lossy compression of photographic images. As the JPEG algorithm is considered at its best on photos of realistic scenes with smooth variations of tone and color, JPEG is the most popular format saved by digital cameras. On the other hand, YUV is a popular color space used in both analog and digital image/video often associated with JPEG. A YUV takes the human perception into account and defines a color space in terms of one luma (Y) and two chrominance (UV) components. The resolution of the chroma data is reduced, often called downsampling, by a factor of 2 for reflecting the fact that the human eye is less sensitive to the fine color details than to the fine brightness details. For JPEG encoding, YUV422 or YUV420 modes (downsampling ratio) are commonly used to reduce the data size for storing image. YUV422, or YUV(4:2:2), is to reduce by the factor of 2 in horizontal direction, and YUV420 (i.e., YUV(4:2:0)) is to reduce by the factor of 2 in horizontal and vertical directions. Then, an image represented in a YUV model is split into blocks of 8×8 pixels. For each block, each of the Y, U and V data must undergo a discrete cosine transform (DCT).

For example, for YUV422 mode, one 16(horizontal)×8(vertical) block (i.e., containing two horizontally adjacent blocks of 8×8 pixels) include two 8×8 Y-planes, one 8×8 U-plane and one 8×8 V-plane. For JPEG encoding, the two Y-planes, one U-plane and one V-plane are fed sequentially into JPEG encoder in the following order for processing: Y-plane, Y-plane, U-plane, V-plane, Y-plane, Y-plane, U-plane, V-plane, . . . and so on. The above sequence is commonly denoted as (Y₀Y₁UV)(Y₀Y₁UV)(Y₀Y₁UV) . . . sequence. Similarly, for YUV420 mode, one 16(horizontal)×16(vertical) block (i.e., containing 2×2 blocks of 8×8 pixels) includes four 8×8 Y-planes, two 8×8 U-planes and two 8×8 V-planes. For JPEG encoding, the four Y-planes, two U-planes and two V-planes are fed sequentially into JPEG encoder in the following order for processing: Y-plane, Y-plane, Y-plane, Y-plane, U-plane, V-plane, Y-plane, Y-plane, Y-plane, Y-plane, U-plane, V-plane, ... and so on. The above sequence is commonly denoted as (Y_{O}Y_{I}Y₂Y₃UV)(Y₀Y₁Y₂Y₃UV)(Y₀Y₁Y₂Y₃UV)... sequence.

For image rotation processing, the most straightforward method is to store the entire frame of image captured by the image input device into the memory. Then, to display the rotated image on an LCD or record the rotated image to a storage device, the stored data of the image can be read in a rotated order. However, this method requires a large amount of data to store the entire frame of image. For example, U.S. Pat. No. 7,352,904 disclosed a block decoding method and system capable of decoding and outputting data in a longitudinal direction, by obtaining a start address in an input compressed data stream for each block of a decompressed image by a pre-scanned compressed data stream so that the system can obtain a 90-degree rotated blocks by performing a Huffman decoding in a longitudinal direction, a 90-degree rotated zigzag arrangement, an inverse quantization and an IDCT.

To reduce the amount of required memory, various methods are developed. For example, U.S. Pat. No. 7,489,823 disclosed a method for using a reentry data set to decode compressed data, where compressed data is received and decoded. A reentry data set is first collected in the first JPEG encoding stage, and then accessed during decoding. An end-of-block (EOB) flag of decoding is detected when decoding a first location in the compressed data. The reentry data set has a pointer to a second location in the compressed data following the first location and decoding information enabling the decoding to start from the second location. The second location in the compressed data is accessed and the decoding information in the accessed reentry data set is used to continue decoding the compressed data from the second location. The reentry information is collected in the first JPEG encoding stage and then decoded for rotation. For rotation, the reentry data set is decoded and then used in the second JPEG encoding/compression stage to encode the input image in the desired rotated direction.

FIG. 1 shows a schematic view of reentry information collected for the YUV422 mode. As shown in FIG. 1, the reentry information includes the start address of each Y-plane, U-plane and V-plane encoded bit stream and the direct current (DC) reference value of each Y-plane, U-plane and V-plane in frequency domain. Hence, for YUV422 mode, one image block of 16×8 pixels will require to record the starting addresses and DC reference values of four planes. Similarly, for YUV420 mode, one image block of 16×16 pixels will require to record the starting addresses and DC reference values of six planes.

### SUMMARY OF THE INVENTION

The present invention has been made to overcome the aforementioned drawback of image rotation methods for display and recording using JPEG compression/decompression. The primary object of the present invention is to provide a method and apparatus of color image rotation for display and recording using JPEG compression and decompression to reduce the amount of reentry information required to save. By reducing the reentry information, both the memory and the time to collect and process the reentry information can be reduced so as to enhance the performance of the color image rotation computing.

Another object of the present invention is to provide a method and apparatus of color image rotation for display and recording using JPEG compression and decompression that enables a smoother decoding process to facilitate a jitter-free display transition process to enhance the user friendliness of the display system.

To achieve the above objects, the present invention provides a method and apparatus of color image rotation for display and recording using JPEG compression and decompression. The method includes the steps of: setting the operation modes of JPEG encoder and JPEG decoder respectively; waiting until the image data ready for encoding; performing JPEG encoding and reentry information processing; waiting until the compression of one entire frame of image completed; setting the operation mode of JPEG encoder; and then performing JPEG decoding and reentry information updating processing. For displaying the image on an image output device, the method includes the steps of: displaying processing; waiting until JPEG decoding completed; and displaying final image on the display. At this point, the process of one frame display is accomplished. On the other hand, for recording to a mass storage device, the method includes the steps of: standard lossless JEPG encoding; waiting until JPEG encoding completed; and storing final encoded data to the mass storage device. At this point, the process to record one frame image is accomplished.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of reentry information collected for the YUV422 mode in conventional color image rotation method;

FIG. 2 shows a schematic view of an apparatus of color image rotation for display and recording using JPEG compression/decompression in an image-based application environment according to the present invention;

FIG. 3 shows a flowchart of a color image rotation method for display and recording using JPEG compression/decompression according to the present invention;

FIG. 4 shows a schematic view of reentry information collected with the inclusion of DC DPCM disabling mechanism and the re-arrangement of the (Y₀UVY₁) input sequence according to the present invention;

FIG. 5 shows a schematic view of the index memory and the incremental size memory for storing the reentry information according to the present invention;

FIG. 6 shows an exemplar of rotating a 32×16-pixel color image of YUV422 mode according to the present invention; and

FIGS. 7A-7H show the detailed processing for the rotation operation of the exemplar in FIG. 6.

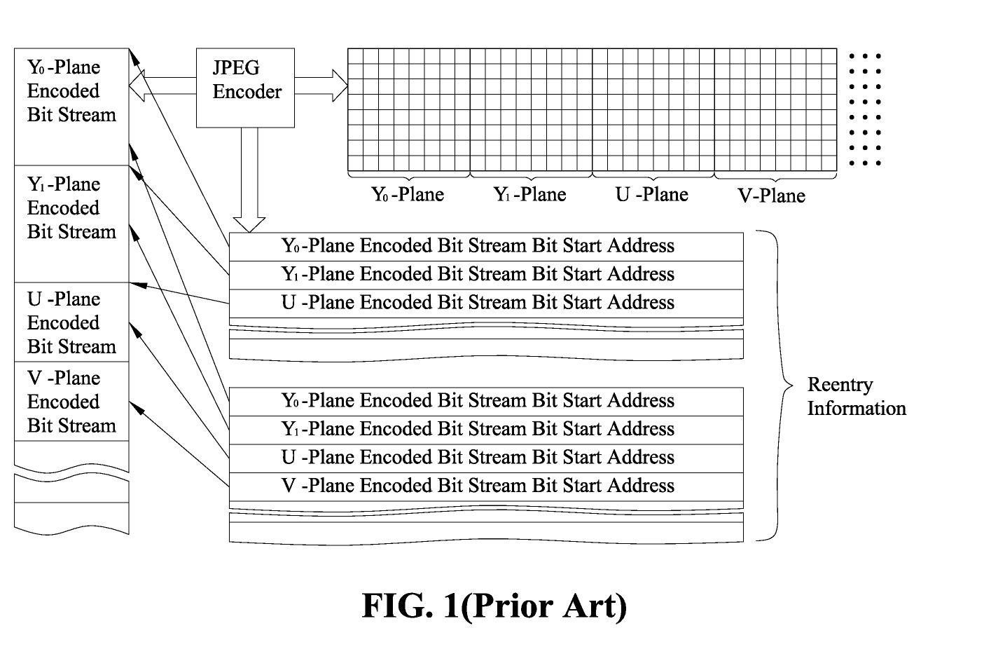

### DETAILED DESCRIPTION OF THE PREFERRED EMBODIMENTS

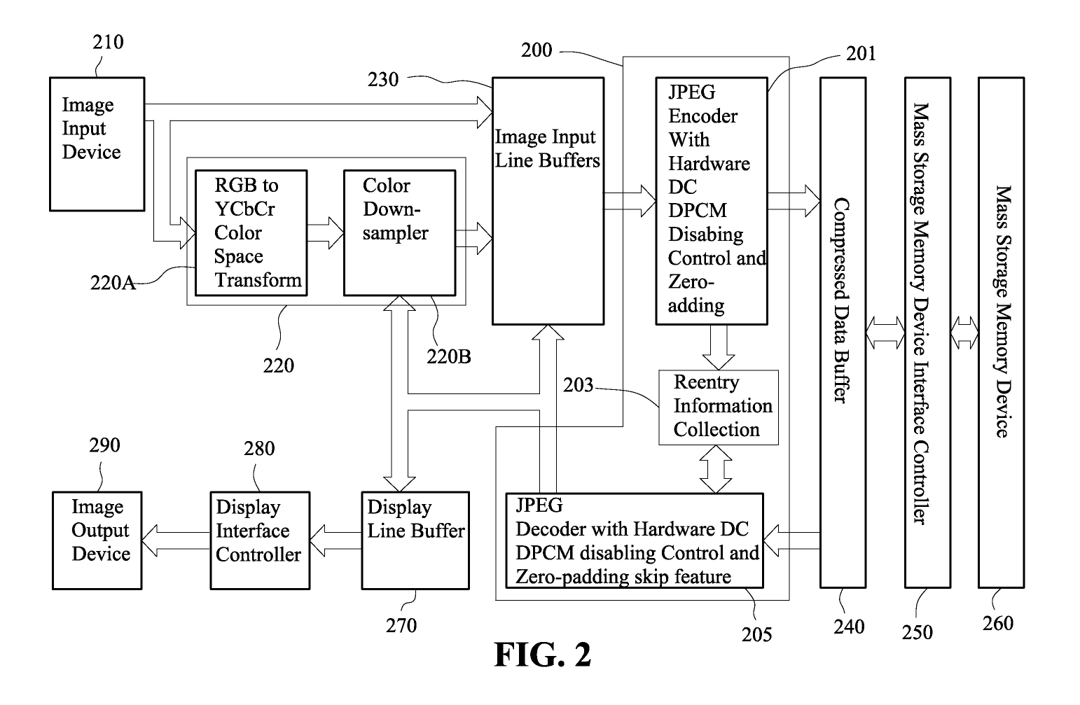

FIG. 2 shows a schematic view of an apparatus of color image rotation for display and recording using JPEG compression/decompression in an image-based application environment according to the present invention. As shown in FIG. 2, a color image rotation apparatus 200 of the present invention includes a JPEG encoder 201 with hardware direct current (DC) differential pulse code modulation (DPCM) disabling control and zero-padding feature, a reentry information collection module 202 and a JPEG decoder 203 with DC DPCM disabling control and zero-padding skip feature. It is worth noting that JEPG encoder 201 and JPEG decoder 203 are both enhanced with a DC DPCM disabling mechanism and zero-padding (or skip) feature. The DPCM disabling mechanism allows JPEG encoder 201 to store the DC value of each Y-plane, U-plane and V-plane in the first stage encoded bit stream, but not the restart marker RST0-RST7 (0×FFD0-0×FFD7) defined in the JPEG standard. The DC DPCM disabling control and zero-padding (or skip) feature to allow byte boundary for memory and performance efficiency will be further described in more details later in the document.

As shown in FIG. 2, color image rotation apparatus 200 of the present invention is placed between an image input device 210 and mass storage memory device 260 to rotate the image captured from image input device 210 before storing to mass storage memory device 260, and between mass storage memory device 260 and image output device 290 before displaying image stored in mass storage memory device 260 on image output device 290. As shown in FIG. 2, an image captured by image input device 210 is either fed to an image input line buffers 230 directly or through a color space transformation 220 prior to image input line buffers 230 and then encoded by JPEG encoder 201 with DC DPCM disabling mechanism and zero-padding feature for first stage JPEG encoding of the present invention. Color space transformation 220 includes an RGB-to-YUV color space transformation 220A and a color down-sampler 220B to transform the RGB format of the color image captured by image input device 210 into YUV format to be used in the first stage JPEG encoding of the present invention. For displaying the rotated image on image output device 290, the JPEG encoded bit stream is then decoded by JPEG decoder 203, and then passes via display line buffers 270 and display interface controller 280 to be displayed on image output device 290. On the other hand, the JPEG encoded bit stream can also be decoded by JPEG decoder 203 and then through a second stage standard JPEG encoding process (i.e., also by JPEG encoder 201) before via compressed data buffer 240 and mass storage memory device interface controller 250 to be stored in a mass storage device 260.

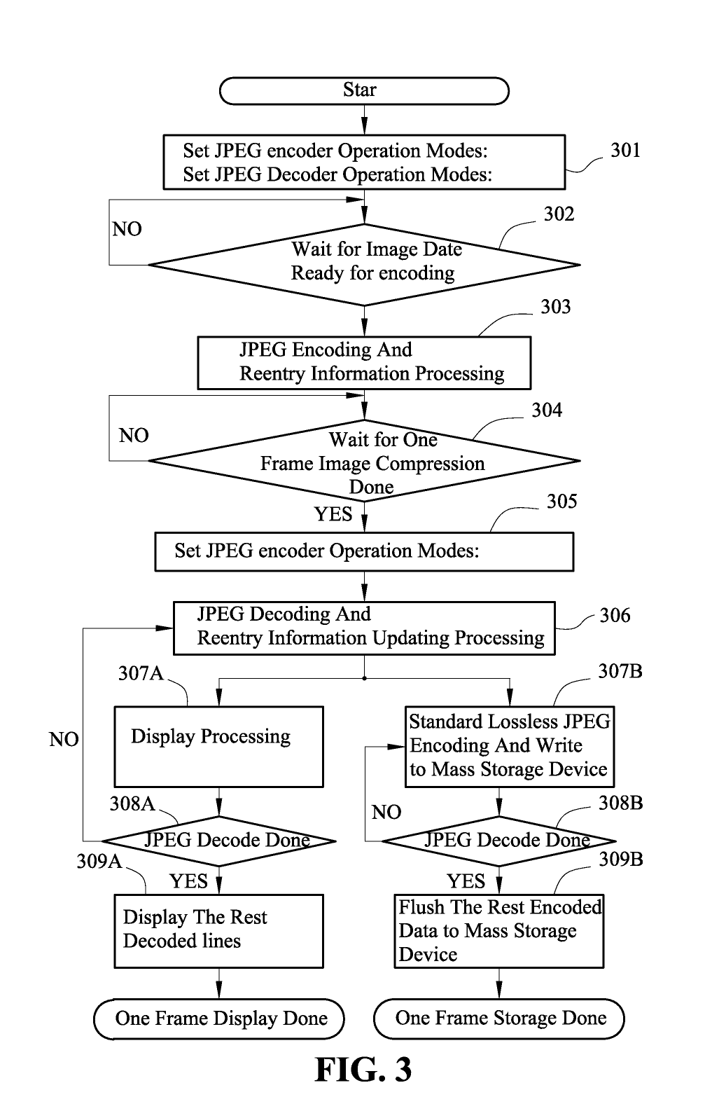

FIG. 3 shows a flowchart of a color image rotation method for display and recording using JPEG compression/decompression according to the present invention. The flowchart uses YUV422 mode as an exemplar, and the description for YUV420 mode is similar. With color image rotation apparatus 200 of FIG. 2, as shown in FIG. 3, step 301 is to set the operation modes of JPEG encoder 201 and JPEG decoder 203 of apparatus 200 respectively. The setting of JPEG encoder 201 operation modes include disabling JPEG encoder DPCM, setting plane input sequence as YUVY and enabling Y-plane zero-padding for byte alignment. Similarly, setting JPEG decoder 203 operation modes includes disabling DC DPCM calculation, setting plane input sequence as YUVY, enabling JPEG decoder to jump to the beginning of the next byte when Y-plane is completed. Step 302 is to wait until the image data ready for encoding. When the image data is ready, step 303 is to perform JPEG encoding and reentry information processing. Step 304 is to wait until the compression of one entire frame of image is completed. After the compression of one frame image is completed, step 305 is to set the operation modes of JPEG encoder 201 as follows: enabling JPEG encoder DPCM, setting plane input sequence as YYUV, disabling Y-plane zero-padding for bye alignment, and setting quantization value as 1, i.e., lossless mode. Step 306 is to perform JPEG decoding and reentry information updating processing.

After step 306, the process can either take step 307A for display processing in order to display the image on an image output device, or take step 307B for standard lossless JEPG encoding for recording to a mass storage device. For displaying processing branch (step 307A), step 308A is to wait until JPEG decoding is completed, and when JPEG decoding is completed, the final image is displayed on the display, as shown in step 309A. At this point, the process of one frame display is accomplished. Similarly, for recording to mass storage device (step 307B), step 308B is to wait until JPEG encoding is completed, and when JPEG encoding is completed, the final encoded data is flushed to the mass storage device, as shown in step 309B. At this point, the process to record one frame image is accomplished.

It is worth noting that, as shown in FIG. 3, to store the standard JPEG encoded bit stream of the rotated image to a mass storage device, a second stage JPEG encoding process is required. The second stage JPEG encoding process is a standard JPEG encoding process. To keep the first quantization results of the first stage JPEG encoding of the present invention, the quantization value is set as 1, i.e., the second stage standard JPEG encoding process is a lossless compression on the first stage JPEG encoded results, as shown in step 307B.

It is also worth noting that a main feature of the method of the present invention is to change the plane input sequence to the JPEG encoder and JPEG decoder, as shown in step 301 and step 305. For YUV422 mode, the plane input sequence is changed from the conventional (Y₀Y₁UV) (Y₀Y₁UV) (Y₀Y₁UV) . . . to (Y₀UVY₁) (Y₀UVY₁) (Y₀UVY₁) . . . , for the first stage encoding, where Y₀ and Y₁ are interchangeable. Furthermore, the (Y₀UVY₁) sequence is more convenient for clockwise rotation JPEG decoding, while (Y₁UVY₀) sequence is more convenient for counterclockwise rotation JPEG decoding. Similarly, for YUV420 mode, the plane input sequence is changed from the conventional (Y₀Y₁Y₂Y₃UV) (Y₀Y₁Y₂Y₃UV) (Y₀Y₁Y₂Y₃UV) . . . to (Y₂Y₀UVY₃Y₁) (Y₂Y₀UVY₃Y₁) (Y₂Y₀UVY₃Y₁) . . . , for the first stage encoding, where Y₂ and Y₀ are interchangeable, and Y₃ and Y₁ are also interchangeable. Furthermore, the (Y₂Y₀UVY₃Y₁) sequence is more convenient for clockwise rotation JPEG decoding, while (Y₁Y₃UVY₀Y₂) sequence is more convenient for counterclockwise rotation JPEG decoding.

With the above change of plane input sequence, the reentry information requires to be collected is reduced to two start addresses for the first stage encoding. For YUV422 mode, the two start addresses included in the reentry information are the start addresses of the first Y-plane and the U-plane of the YUVY sequence. Also, for YUV420 mode, the two start addresses included in the reentry information are the start addresses of the first Y-plane and the U-plane of the YYUVYY sequence. In this manner, the memory required to save the reentry information is greatly reduced, and the processing time is also reduced as well.

Furthermore, in addition to reducing required memory for reentry information, the JPEG decoding process will also become smoother as the result of the timing change of start address of encoded bit stream. For YUV422 mode, three planes are now decompressed to obtain the YUV values of the color image of one 8×8-pixel block. The arrangement of (Y₀UVY₁) sequence allows the JPEG decoder to decode the Y₀UV three planes, or UVY₁ three planes to obtain a color image of one 8×8-pixel block. For YUV420, four planes are now decompressed to obtain the YUV values of the color image of two 8×8-pixel blocks. The arrangement of (Y₂Y₀UVY₃Y₁) sequence allows the JPEG decoder to decode the Y₂Y₀UV four planes, or UVY₃Y₁ four planes to obtain a color image of two 16×8-pixel blocks. The performance is improved and the overall decompression is more efficient and smooth.

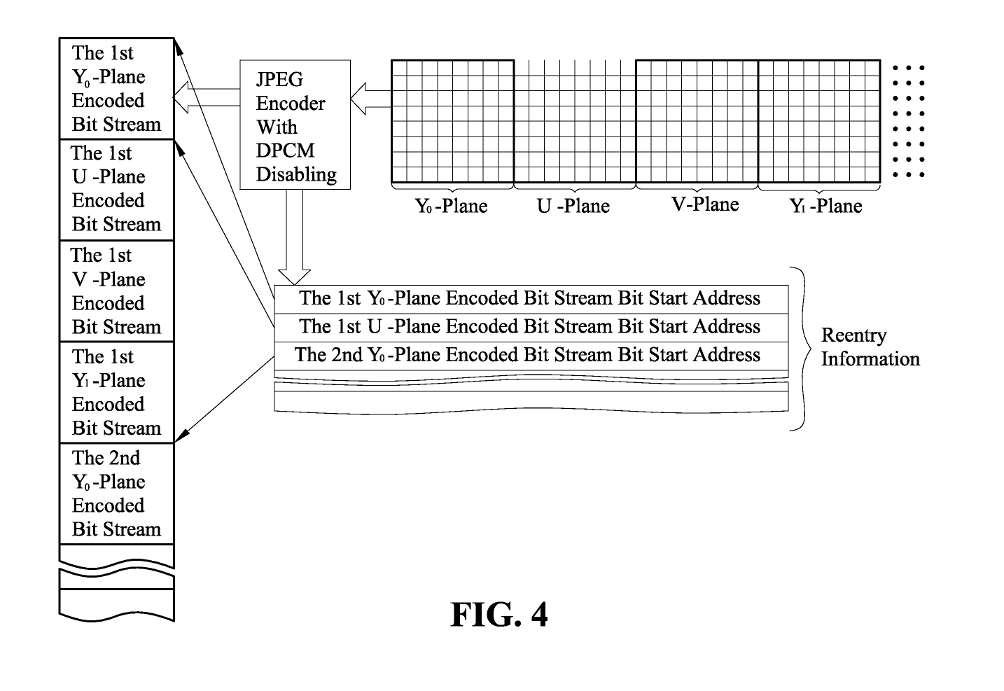

As aforementioned, JPEG encoder 201 is enhanced with DC DPCM disabling mechanism. The inclusion of DC DPCM disabling mechanism, as shown in FIG. 4, enables the re-arrangement of the (Y₀UVY₁) input sequence to reduce the amount of reentry information required to be saved for encoding/compression computation. As shown in FIG. 4, the (Y₀UVY₁) input sequence are fed to the JPEG encoder with DC DPCM disabling mechanism. For JPEG encoding/compression the DPCM is disabled and the original DC reference value for reentry information is stored in the encoded/compressed bit stream without inserting the JPEG defined RESTART marker. The reentry information to be collected, as shown in FIG. 4, includes the Y₀-plane encoded bit stream start address and the U-plane encoded bit stream start address.

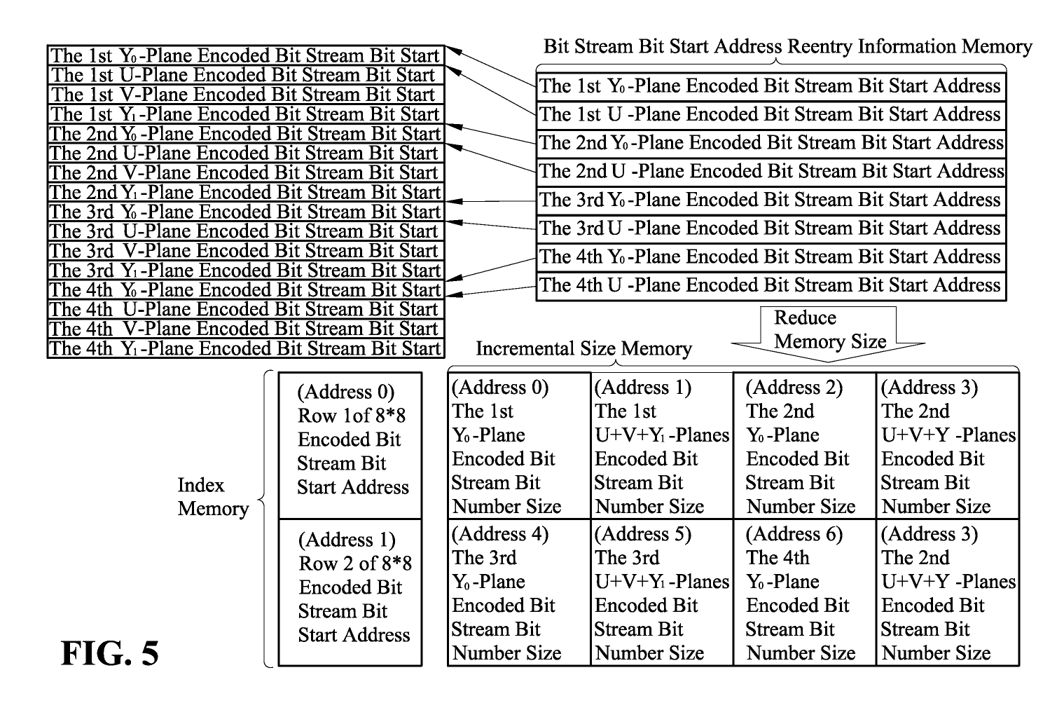

To further reduce the amount of the memory required for recording reentry information, an additional mechanism can be used. FIG. 5 shows that instead of storing the entire start addresses of the Y₀-plane encoded bit stream and U-plane encoded bit stream, an index memory and an incremental size memory can be used to reconstruct the start addresses. As shown in FIG. 5, the index memory stores the start address of the encoded bit stream, while the incremental size memory stores the Y₀-plane encoded bit size or the sum of the encoded bit sizes of U-plane, V-plane and Y₁-plane. The address number in parentheses, e.g., (address 0), indicates the address of the memory location storing the value. For example, address 0 of index memory stores the start address of the row 1 of 8×8 encoded bit stream, address 0 of incremental size memory stores the total number of bits in the 1^{st} Y₀ plane and address 1 of incremental size memory stores the total number of bits in the 1^{st} U+V+Y₁-planes encoded bit stream. In this manner, the actual start addresses of Y₀-plane encoded bit stream and the U-plane encoded bit stream can be reconstructed with the values stored in the index memory and the incremental size memory.

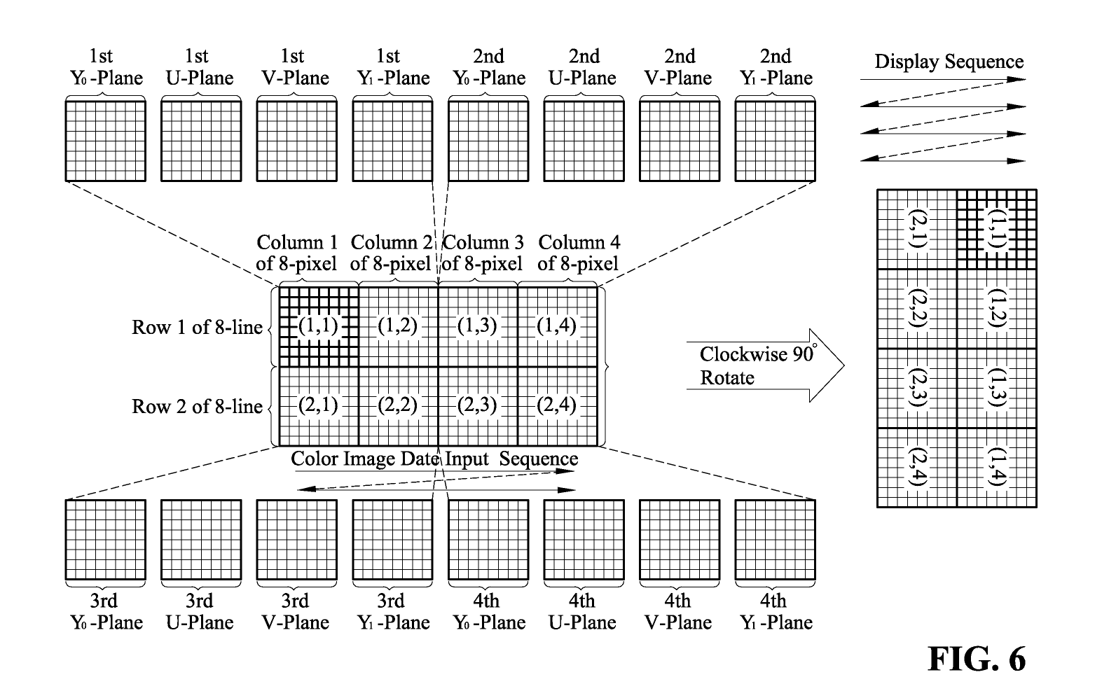

FIG. 6 shows an exemplar of rotating a 32×16-pixel color image of YUV422 mode according to the present invention. As shown in FIG. 6, the 32×16-pixel color image is divided into eight 8×8 blocks, marked as (1,1), (1,2), (1,3), (1,4), (2,1), (2,2), (2,3), (2,4), respectively. The arrow below the original color image shows the color image data input sequence. A 90° clockwise rotation is performed on the 32×16 color image to become a 16×32 color image, as shown in the right part in FIG. 6. The arrow above the rotated color image shows the display sequence of the bit stream. The remaining Y-planes, U-planes and V-planes above and below the original 32×16 color image are all the planes need to be processed for the rotation operation. As the exemplar is for YUV422 mode, four planes are included for each two adjacent blocks (i.e., one 16×8 image). Hence, the original 32×16 color image will be divided into four parts, marked as 1^{st}, 2^{nd}, 3^{rd} and 4^{th}, respectively.

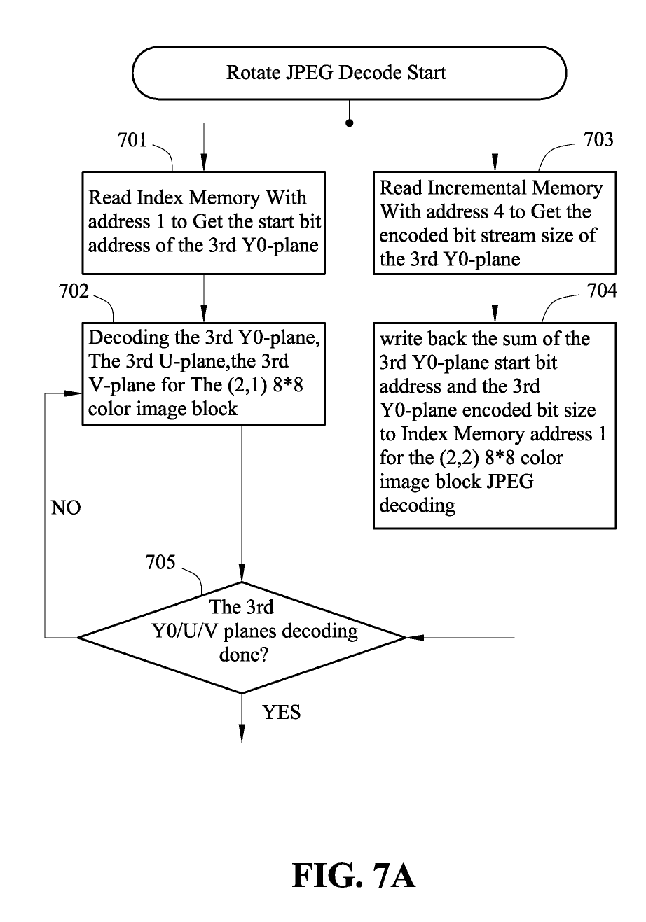

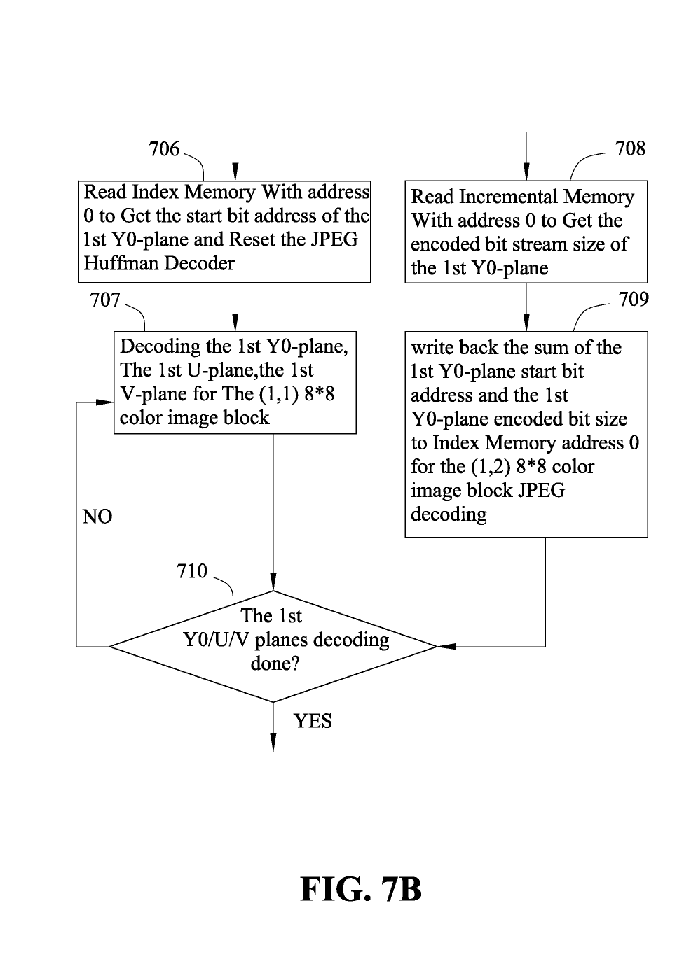

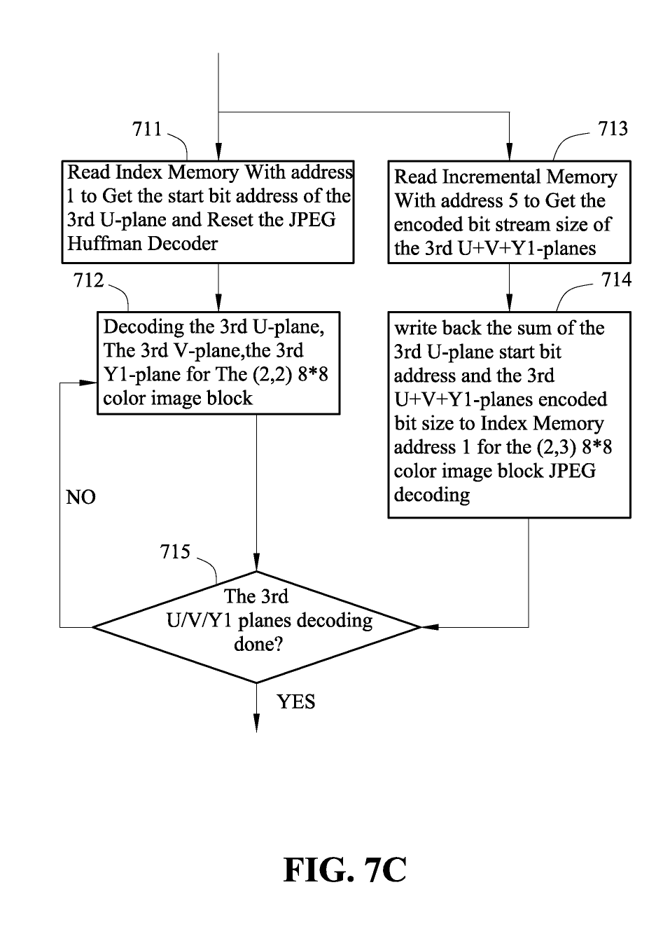

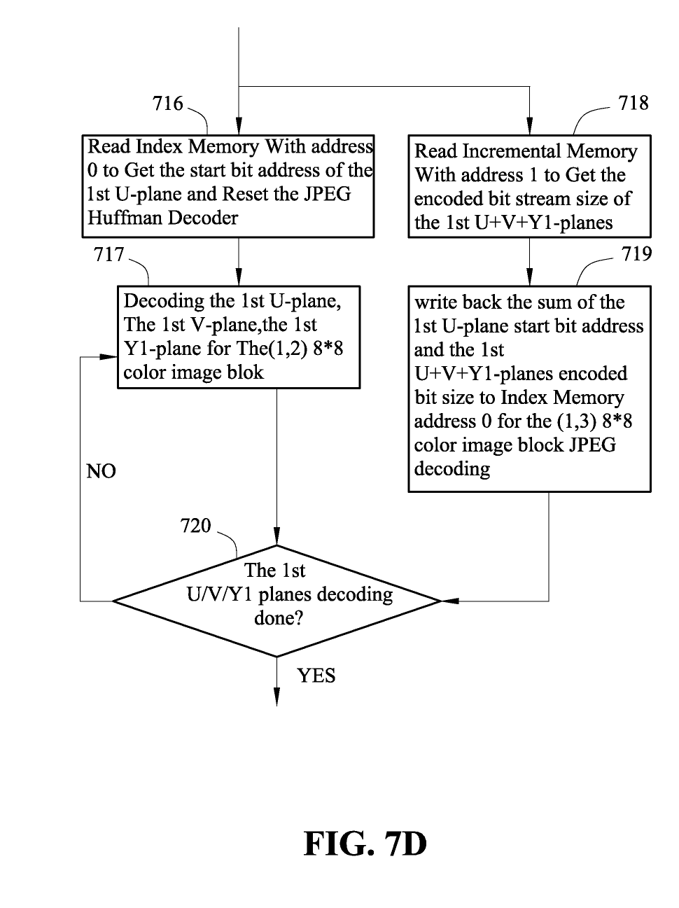

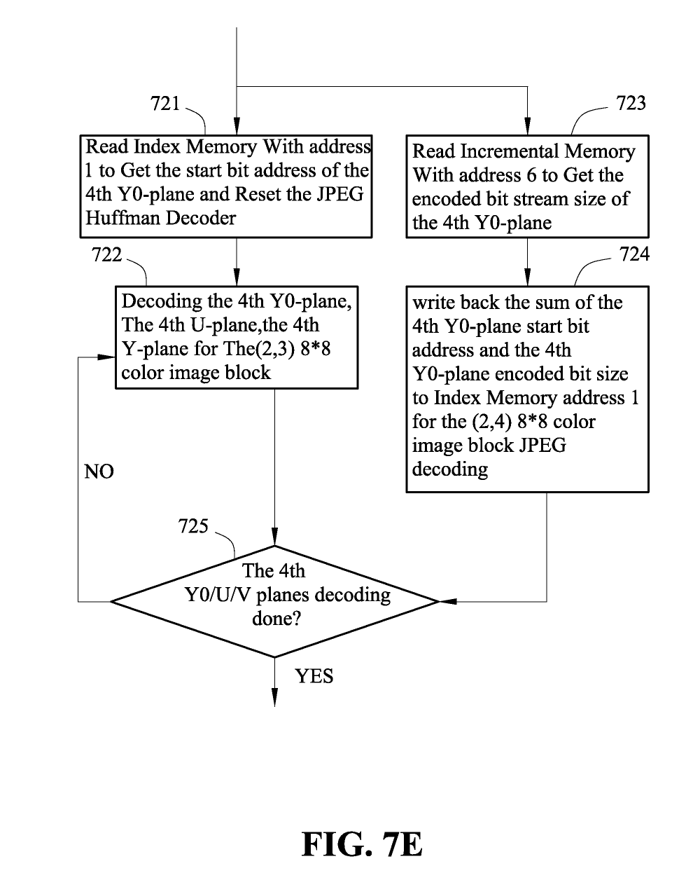

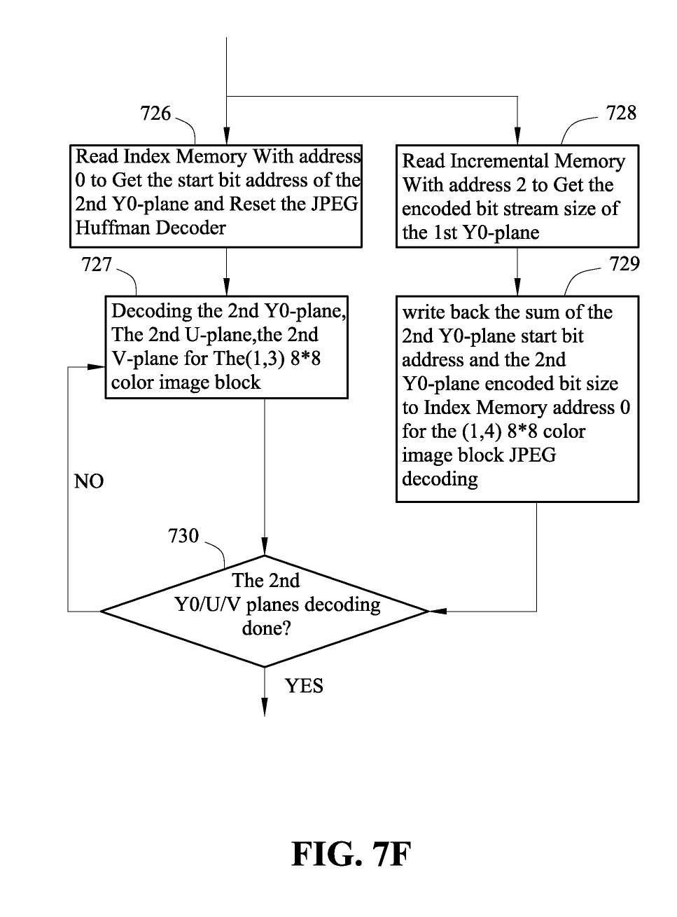

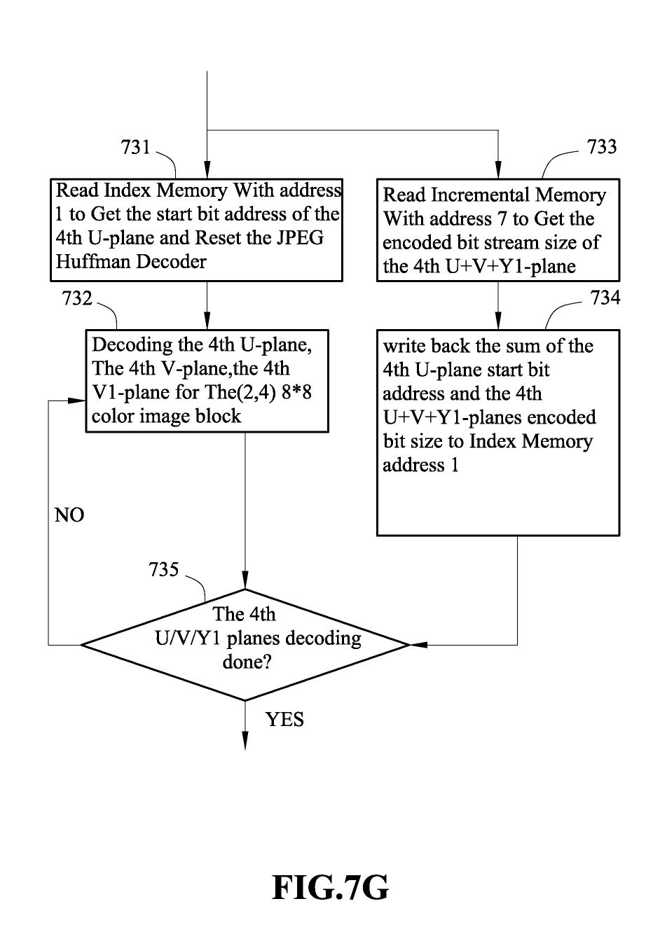

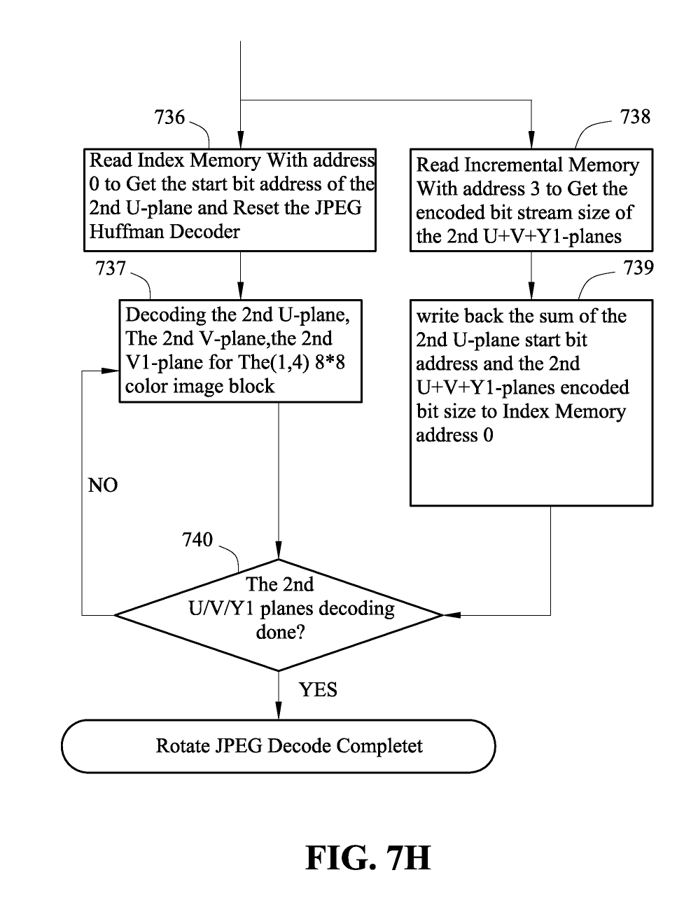

FIGS. 7A-7H show the detailed processing for the rotation operation in FIG. 6. As shown in FIG. 7A, step 701 is to read index memory with address 1 to obtain start bit address of 3^{rd} Y₀-plane and step 702 is to decode 3^{rd} Y₀-plane, 3^{rd} U-plane, 3^{rd} V-plane for (2,1) block. Similarly, step 703 is to read incremental memory with address 4 to obtain encoded bit stream size of 3^{rd} Y₀-plane and step 704 is to write back the sum of 3^{rd Y}₀-plane start bit address and 3^{rd} Y₀-plane encoded bit size to index memory address 1 for the (2,2) block JPEG decoding. It is worth noting that accessing the index memory and the incremental size memory can be conducted concurrently. Step 705 is to determine whether 3^{rd} Y₀-plane, 3^{rd} U-plane, 3^{rd} V-plane decoding are completed; if so, the process proceed to step 706; otherwise, the process returns to step 702.

Similarly, in FIG. 7B, step 706 is to read index memory with address 0 to obtain start bit address of 1^{st} Y₀-plane and reset the JPEG Huffman decoder, and step 707 is to decode 1^{st} Y₀-plane, 1^{st} U-plane, 1^{st} V-plane for (1,1) block. Similarly, step 708 is to read incremental memory with address 0 to obtain encoded bit stream size of 1^{st} Y₀-plane and step 709 is to write back the sum of 1^{st} Y₀-plane start bit address and 1^{st} Y₀-plane encoded bit size to index memory address 0 for the (1,2) block JPEG decoding. Step 710 is to determine whether 1^{st} Y₀-plane, 1^{st} U-plane, 1^{st} V-plane decoding are completed; if so, the process proceed to step 711; otherwise, the process returns to step 707.

FIG. 7C shows the decoding of the 3^{rd} U-plane, 3^{rd} V-plane and 3^{rd} Y₁-plane. As shown in FIG. 7C, step 711 is to read index memory with address 1 to obtain start bit address of 3^{rd} U-plane and reset the JPEG Huffman decoder, and step 712 is to decode 3^{rd} U-plane, 3^{rd} V-plane, 3^{rd} Y₁-plane for (2,2) block. Similarly, step 713 is to read incremental memory with address 5 to obtain encoded bit stream size of 3^{rd} U+V+Y₁-planes and step 714 is to write back the sum of 3^{rd} Y₀-plane start bit address and 3^{rd} U+V+Y₁-planes encoded bit size to index memory address 1 for the (2,3) block JPEG decoding. Step 715 is to determine whether 3^{rd} U-plane, 3^{rd} V-plane, 3^{rd} Y₁-plane decoding are completed; if so, the process proceed to step 716; otherwise, the process returns to step 702.

Similarly, steps 716-720 of FIG. 7D are the steps for decoding 1^{st} U-plane, 1^{st} V-plane and 1^{st} Y₁-plane. Steps 721-725 of FIG. 7E are the steps for decoding 4^{th} Y₀-plane, 4^{th} U-plane and 4^{th} V-plane. Steps 726-730 of FIG. 7F are the steps for decoding 2^{nd} Y₀-plane, 2^{nd} U-plane and 2^{nd} V-plane. Steps 731-735 of FIG. 7G are the steps for decoding 4^{th} U-plane, 4^{th} V-plane and 4^{th} Y₁-plane. Steps 736-740 of FIG. 7H are the steps for decoding 2^{nd} U-plane, 2^{nd} V-plane and 2^{nd} Y-plane. All the detailed descriptions are omitted here.

As aforementioned, JPEG encoder 201 and JPEG decoder 203 of the present invention are also enhanced with a zero-padding feature to allow padding bits of zero to the byte boundary so that start address of the bit stream of reentry information can be aligned as the start address of the bit stream byte. By padding bits of zero to Y-plane when the Y-plane encoded bit stream size is not exactly a multiple of byte. Zero-padding to byte boundary can reduce the sizes of the index memory and the incremental size memory as well as the reentry information processing complexity as the processing is now based on byte address instead of bit address. The JPEG decoder with the zero-padding feature will allow the decoding to jump to the start of the next byte when decoding Y-planes.

Therefore, with the zero-padding for Y-planes the rearranged Y₀UVY₁ input sequence for JPEG encoding, the start addresses of Y₀-planes and U-planes are exactly at the byte boundary for YUV422 mode. The reentry information will include the start byte addresses of the JPEG encoded bit stream but not bit addresses. Similarly, for YUV420 mode, with the zero-padding for Y₀-planes and Y₁-planes, i.e., the second and fourth Y-planes, the rearranged Y₂Y₀UVY₃Y₁ input sequence for JPEG encoding, the reentry information will also include the start byte addresses of the JPEG encoded bit stream.

Furthermore, to display the rotated image on an image output device, the index memory must be restored to the initial values after the first stage JPEG encoding process of the present invention. The restoration of the index memory to the initial values can be accomplished by a shifting process, i.e., by shifting the initial values so that the value stored in address n becomes the value of address n-1, and the value of address 0 is set as 0.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of color image rotation for display and recording using JPEG compression/decompression, applicable to an apparatus with a JPEG decoder with DC DPCM disabling mechanism and zero-padding feature, a reentry information collection module and a JPEG decoder with DC DPCM disabling mechanism and zero-padding skip feature, said method comprising the steps of:
setting operation modes of said JPEG encoder and said JPEG decoder, respectively;
waiting until image data ready for encoding;
performing JPEG encoding and reentry information processing;
waiting until completing compression of one entire frame of image;
setting operation mode of said JPEG encoder;
performing JPEG decoding and reentry information updating processing;
performing a display/recording process, said display/recording process further comprising the steps of:
for displaying rotated image on an image output device:
displaying processing;
waiting until JPEG decoding completed; and
displaying final image on said image output device to accomplish display one frame of rotated color image; and
for recording rotated image on an mass storage device:
performing lossless JPEG encoding ;
waiting until JPEG encoding completed; and
flushing final encoded data to said mass storage device to accomplish recording one frame of rotated color image.

2. The method as claimed in claim 1, wherein said The method as claimed in claim 1, wherein said step of setting operation modes of said JPEG encoder and said JPEG decoder respectively further comprises the steps of:
disabling JPEG encoder DPCM;
setting plane input sequence to said JPEG encoder as YUVY for YUV422 mode or as YYUVYY for YUV 420 mode;
enabling said JPEG encoder Y-plane zero-padding for byte alignment;
disabling JPEG decoder DC DPCM calculation;
setting plane input sequence to said JPEG encoder as YUVY for YUV422 mode or as YYUVYY for YUV 420 mode; and
enabling said JPEG decoder to jump to beginning of next byte when completing Y-plane.

3. The method as claimed in claim 1, wherein said step of setting said JPEG encoder further comprises the steps of:
enabling JPEG encoder DPCM;
setting plane input sequence to said JPEG encoder as YYUV for YUV 422 mode and as YYUVYY for YUV420 mode;
disabling Y-plane zero-padding for bye alignment; and
setting quantization value as 1 to become lossless mode.

4. The method as claimed in claim 2, wherein said step of disabling DC DPCM further comprises not to insert RESTART marker defined by standard JPEG.

5. The method as claimed in claim 2, wherein said reentry information comprises start address the first Y-plane and start address of U-plane of said YUVY sequence for YUV422 mode and of said YYUVYY sequence for YUV 420 mode.

6. The method as claimed in claim 5, wherein said start addresses of said reentry information are reconstructed by start address of encoded bit stream, number of bits in Y-plane of encoded bit stream and number of total bits in U-plane, V-plane and Y-plane of encoded bit stream.

7. An apparatus of color image rotation for display and recording using JPEG compression/decompression, comprising:
a JPEG encoder with DC DPCM disabling mechanism and zero-padding feature;
a reentry information collection module; and
a JPEG decoder with DC DPCM disabling hardware and zero-padding skip feature.

8. The apparatus as claimed in claim 7, wherein said reentry information collection module further comprises an index memory for storing address of start bit of encoded bit stream, and an incremental size memory for storing number of bits of Y-plane of encoded bit stream and number of total bits of U-plane, V-plane and Y-plane of encoded bit stream.

9. The apparatus as claimed in claim 8, wherein said index memory can restore initial values by a shift operation.
